(19) United States
(12) Patent Application Publication
(10) Pub. No.: US 2009/0173393 A1
(43) Pub. Date: Jul. 9, 2009

(54) PRESSURE RELIEF DEVICE

(75) Inventors: Stefan Grabert, Karlsruhe (DE); Wolfgang Markus, Karlsruhe (DE)

Correspondence Address: MCGLEW & TUTTLE, PC, P.O. BOX 9227, SCARBOROUGH STATION, SCARBOROUGH, NY, 10510-9227, US

(73) Assignee: Hankuk University of Foreign Studies Research & In, Yongin (KR)

(21) Appl. No.: 12/304,166

(22) PCT Filed: Jun. 21, 2007
(86) PCT No.: PCT/EP2007/005461

§ 371 Date: Dec. 10, 2008

(30) Foreign Application Priority Data
Jun. 27, 2006 (DE) 10 2006 029 356.8

(51) Int. Cl. F16K 17/14

(52) U.S. Cl. 137/68.23

(57) ABSTRACT

The invention relates to a device for internal pressure relief of a pig movable through a pipeline and/or some other pressure-tight sealed working implement introduced into an external pressure medium and having a pressure relief valve. To increase the classification for operational reliability, it is proposed that at least one rupture disk be placed downstream of the pressure relief valve in the pressure relief direction.

### FIELD OF THE INVENTION

The invention relates to a device for internal pressure relief for a pig movable through a pipeline and/or a working implement sealed in pressure-tight manner introduced into an external pressure medium with a pressure relief valve.

### BACKGROUND OF THE INVENTION

For testing and cleaning pipelines for liquid or gas transportation pig-like implements are known having a pressure-tight housing and/or a plurality of pressure-tight sealed individual components, so as in this way to reliably protect their internal equipment, particularly highly sensitive electronic components, batteries, etc., against the entry of the external pressure medium. The problem arises of counteracting damage or destruction of the internal equipment in the case of spontaneously arising internal overpressures, which e.g. emanate from explosions of the batteries in the interior.

Operational reliability with respect to the pressure relief also has vital importance for the purpose of protecting persons located in the environment of such an implement, e.g. following on to an inspection in a pressurized pipeline.

For the internal pressure relief of such an implement normally pressure relief valves are provided in the housing which, in the case of an internal pressure rise, ensure a pressure compensation with the outer area. However, it has been found that the operational reliability and security of such an arrangement is inadequate. Thus, cases repeatedly occur of gas entering magnetic flux measuring devices, such as are used for test pigs for pipe wall measurement, part of said events being attributable to the pressure relief valve. On introducing such a measuring device into a liquid pressure medium, particularly crude oil, a complete destruction thereof must be expected. However, much more expensive ultrasonic measuring devices are provided for use in crude oil pipes.

The high failure probability of such a pressure relief valve in particular arises due to the large number of sealing rings used, which are in direct contact with the pressure medium. Damage to such a sealing ring can also lead to a residual overpressure in the implement as a result of an unfavourable displacement of the defective sealing ring, which gives rise to a danger source for persons in the vicinity of the implement. In order to largely prevent such failures, following each measurement pass it is necessary to carry out a time-consuming, costly inspection regarding serviceability. The number of pressure relief valves kept in stock must be twice the number of pressure relief valves actually used in order not to further delay the use of the measuring device following time-consuming inspection and testing.

There is also the problem that an implement with the aforementioned construction is not in accordance with existing ignition protection regulations, such as e.g. the ATEX product directive 94/9/EG (“ATEX 9511), where as a result of construction it is difficult to implement a classification within such an explosion protection standard. However, such a classification would be desirable for increasing standardization and monitoring for operational reliability.

Whilst avoiding the aforementioned problems, the object of the invention is to provide an internal pressure relief device, which can in particular be classified within and which conforms to the explosion protection regulations of the ATEX product directive 94/9/EG (“ATEX 9511), so as in this way to satisfy or even exceed high operational reliability standards.

### SUMMARY OF THE INVENTION

According to the invention this object is achieved with a device of the aforementioned type, which is characterized by at least one rupture or bursting disk, which is located downstream of the pressure relief valve in the pressure relief direction.

Thus, with respect to the protection of the internal equipment, through the rupture disk and pressure relief valve a redundant arrangement is formed, which in an emergency can fulfil its sealing function e.g. if the rupture disk is damaged. Due to such an arrangement the inventive internal pressure relief device fulfils the safety function of a test valve, which can be combined with the sealing action of a sealing plug, so that a high safety standard is achieved. This in particular permits a pressure relief in the case of an internal overpressure, whilst the overall device is encapsulated in pressure-tight manner against external pressure. As a result of the inventive arrangement of the rupture disk behind the pressure relief valve it is possible to ensure a high pressure seal with respect to the pressure medium in the outer area.

In a preferred development the rupture disk is constructed in such a way that compared with its inside facing the pressure relief direction it withstands an at least ten times higher pressure on its outside. It can in particular be provided that as from a pressure of approximately 20 bar acting on its inside in the pressure relief direction, the rupture disk opens. It can withstand a pressure acting on its outside of up to 260 bar.

In an extremely preferred further development of the invention, it is proposed that at least one flashback arrester is arranged in series with the pressure relief valve and rupture disk. Such a series arrangement of the flashback arrester ensures the operational reliability of the individual components, even in the case of neighboring explosions and/or flashbacks. In a preferred development the flashback arrester is positioned in the pressure relief direction upstream of the pressure relief valve and/or upstream of the rupture disk. According to the invention such an arrangement of a flashback arrester is particularly necessary if e.g. due to existing explosion risks or due to country-specific regulations an ATEX certification is required. For example, in the case of inspections in water pipes, where the explosion risk is low or non-existent, there is no need to provide a flashback arrester.

To avoid contamination by particles in the exterior and thereby prevent the associated clogging effects, according to a further development of the invention at least one filter, preferably a sintered filter is provided, which is in series with the pressure relief valve, rupture disk and optionally the flashback arrester. A filter is preferably positioned in the pressure relief direction as the final element of the row. Alternatively or additionally a filter can be placed between the pressure relief valve and the rupture disk.

To bring about a pressure-tight encapsulation with respect to the external pressure medium, in a highly preferred development the pressure relief valve, rupture disk and optionally flashback arrester are integrated into a common housing. This leads to the more specific advantage that the pressure relief valve is not in direct contact with the external pressure medium, so that it is less stressed and there is no need for its regular maintenance and operational inspection. In order to ensure a high pressure tightness between the pressure relief valve and the housing inner wall adjacent thereto in the pressure relief direction, a sealing ring can be provided for pressure sealing of the pressure relief valve area adjacent to the inner wall of the housing.

In another development of the invention it is proposed that the housing has a main section, an intermediate part, a cover section and a pressure-tight connection between at least two of the individual sections, particularly between the main section and the intermediate section. The pressure-tight connection can be formed by welding individual sections of the housing, e.g. during an electron beam welding process. The different means arranged in series are integrated into different housing sections, which allows a particularly simple assembly of the device. It can in particular be provided that the pressure relief valve and flashback arrester are integrated into the main section of the housing. In addition, at least one filter can be integrated into the cover section and/or into the main section of the housing. For aligning the rupture disk between the other means present, it can be integrated in pressure-tight manner in its own housing section, particularly in the housing intermediate part.

To bring about a high stability and corrosion resistance of the housing, the latter is made from high-grade steel.

For the pressure-tight joining of the interior of the implement with the housing interior a screw coupling is proposed and the housing has a thread for pressure-tight connection to the implement housing. In a preferred development said thread is provided terminally on the housing main section. To meet the high safety demands, the thread conforms with the provisions of a pressure-resistant encapsulation according to European standard EN 60079-1, particularly with regards to the slope and connection length. Means located in the housing interior are also preferably constructed so as to conform with European standard EN 60070-1, e.g. the flame arrester, which for this purpose can have a serrated connection.

In a highly preferred development, the inventive device is used in an explosion-protected housing of a pig movable through a pipeline and/or an implement introduced in pressure-tight sealed manner into an external pressure medium for removing internal overpressures in the outer area of the housing.

### BRIEF DESCRIPTION OF THE DRAWINGS

The invention is described in greater detail hereinafter relative to preferred embodiments illustrating the further characteristics and advantages of the invention with reference to the attached drawings, wherein show:

FIG. 1 A diagrammatic sectional view of an inventive pressure relief device in a first embodiment.

FIG. 2 A diagrammatic sectional view of an inventive pressure relief device in a further development of the first embodiment.

FIG. 3 A diagrammatic sectional view of an inventive pressure relief device in a further embodiment.

### DETAILED DESCRIPTION OF THE DRAWINGS

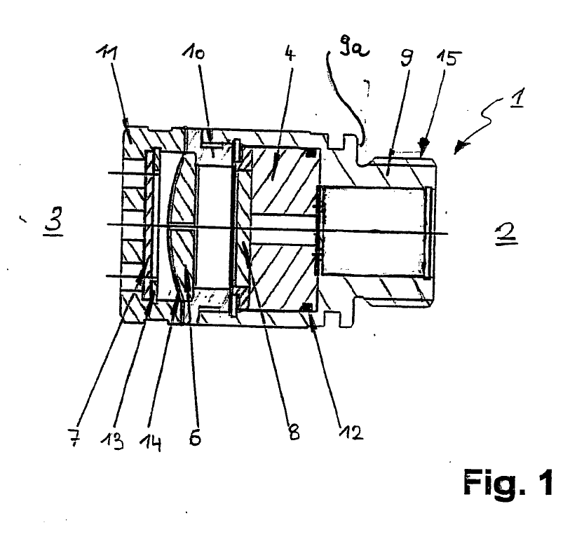

In a diagrammatic side view FIG. 1 shows a pressure relief device 1 for internal pressure relief of a pressure-tight sealed, pig-like working implement, 2 being the interior of the implement and 3 the exterior in which a pressure relief can take place.

Device 1 has a high-grade steel housing 9, 10, 11 with a main section 9, an intermediate part 10 and a cover section 11. The main section of housing 9 is essentially formed by two lined up hollow cylinders with different internal/external diameters, the hollow cylinder with the smaller internal/external diameter being placed on the side facing the implement interior 2. For the pressure-tight connection of the housing interior to the implement interior 2, along the area with the smaller external diameter the housing main section 9 has a thread 15 which, with respect to the thread length and slope, conforms to the ignition protection regulations of European standard EN 60079-1. By means of the thread 15 the inventive device is screwed into the equipment to be protected, whilst providing a not shown sealing ring between thread 15 and the housing shoulder 9a.

The housing intermediate part 10 is mounted on the end side of the housing main section 9 remote from the implement interior 2 and has an annular design with three different external diameters in the manner of a tyre rim. The end region of the housing intermediate part 10 with the largest external diameter corresponds in its circumference to that of the terminally adjacently positioned end area of the housing main section 9. The middle area and the other end area of the housing intermediate part 10 are placed in the interior of the housing main section 9, the outer circumference of the other end area corresponding to the internal circumference of the housing main section 9 and the middle area has a somewhat smaller external circumference.

The cover section 11 is in the form of a terminally covered hollow cylinder, the covering having three openings and being placed on the end side of the pressure relief device 1 remote from the implement interior 2. The internal/external diameter of the cover section 11 corresponds to that of the area of the housing intermediate part 10 connecting on to its other end side.

A high pressure sealing action of this arrangement is brought about by high-grade welding of the individual elements 9, 10, 11, i.e. the housing main section 9, housing intermediate part 10 and cover section 11, e.g. in connection with an electron beam welding process. To this end the individual elements 9, 10, 11 are made from high-grade steel. Alternatively the housing intermediate part 10 can be a sealing ring 10 e.g. formed from an elastomer and which ensures the pressure seal between the high-grade 5 steel housing sections 9 and 11.

Within the housing main section 9 are provided a pressure relief valve 4 and a sintered filter 8, which are successively arranged in this order in the pressure relief direction from the interior of the implement 2 to the exterior 3. The individual elements 4, 8 have a cylindrical shape, whose external circumference corresponds to the internal circumference of the housing main section 9. The pressure relief valve 4 and sintered filter 8 are integrated into the hollow cylinder with the larger internal/external diameter of the housing main section 9.

A perforated supporting disk 6 is mounted terminally in the inner area of the housing intermediate part 10 on the side with the larger external diameter, the housing intermediate part 10 having a larger internal diameter on the area provided for this purpose. Alternatively, in said area, the internal diameter of the housing intermediate part 9 can correspond to a constant internal diameter of the complete housing end piece. The shape of the perforated supporting disk 6 corresponds to a half-discus, the side facing the implement interior 2 being continuously flat and the side remote from the implement interior 2 being given a convex construction towards the exterior. Connecting on to the side of the housing intermediate part remote from the implement interior 2, a membrane-like bursting or rupture disk 14 is adjacently provided in such a way that it is adapted to the convexly curved surface configuration of the perforated supporting disk 6 and in the case of an external pressure directed from the outer area into the implement interior is supported on said surface of the perforated supporting disk 6. In its marginal area the rupture disk 14 extends over and beyond the surface of the perforated supporting disk 6 located in the inner area of the housing intermediate part 10 between the marginal areas of the cover section 11 and the housing intermediate part 10. The rupture disk 14 has a pressure-tight connection with the inner area of the housing intermediate part 10, which can e.g. be implemented by welding the two individual elements 10 and 6 or 14, particularly by electron beam or laser welding.

A filter 7, such as a sintered filter, is terminally provided in the inner area of the cover portion 11 on the covering thereof and behind the rupture disk 14, whilst a sintered filter 8 is lined up between the perforated supporting disk 9 and the pressure relief valve 4.

According to the invention the cooperation of the individual components lined up in the pressure relief direction and which are in particular formed by the pressure relief valve 4 and the rupture disk 14, bring about an overpressure relief of the implement, particularly in the case of a sudden internal pressure rise, such as e.g. occurs following an explosion in the implement interior, the device 1 satisfying the high safety standards such as ATEX 95 or EN 60079-1 and where there can be a controlled depressurization of the internal pressure rise. The functionality of a test valve in the pressure relief direction 3 results from the rupture disk 14 placed on the opposite side of pressure relief valve 5, i.e. there is a selective depressurization from the interior 2 to the exterior of the implement only in the case of an inadmissibly increased internal pressure. For this purpose the rupture disk 14 is constructed in such a way that on the side facing the outer area it withstands an external pressure of up to 260 bar, whereas on the side facing the implement interior 2 it ruptures or bursts at an internal pressure of 20 bar. Following the rupture of the membrane-like rupture disk 14 the gases flow through the flashback arrester and cool to such an extent that the ignition of any explosive atmosphere present is reliably prevented. The individual elements lined up in the pressure relief direction are fixed in such a way as to oppose or withstand the pressure loss which occurs.

A further increase in the operational reliability is brought about by the arrangement of particle filters in series with the indicated components and which are here in the form of a sintered filter 8 and a further filter 7, so that a contamination of the pressure relief device 1 by the penetration of particles present in the exterior is prevented or at least reduced.

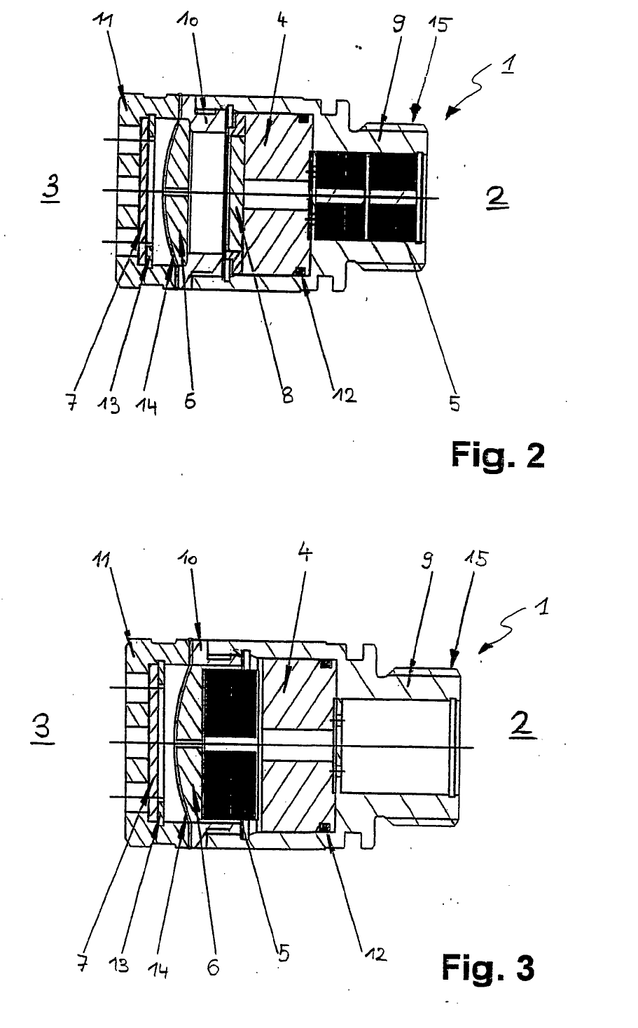

FIG. 2 shows the inventive pressure relief device in a further development of the embodiment shown in FIG. 1.

As a result of the flashback arrester 5 placed directly in the implement interior 2 with additional reliability a destruction of the means 4, 6, 14, especially following an explosion in the implement interior is prevented. The construction of the flashback arrester 5 is inter alia dependent on the composition of the gases which can ignite in order to consequently satisfy the above-described ignition protection regulations. In the embodiment shown in FIG. 2 the flashback arrester 5 is formed by two 10 mm long, successively arranged individual components, so as overall to ensure an above-described gap length exceeding 12.5 mrn.

FIG. 3 shows an alternative construction of the inventive pressure relief device 1. No sintered filter 8 is provided between the pressure relief valve 4 and the perforated supporting disk 6. It is replaced by lining up the flashback arrester 5 between these two individual elements 4, 6. As a result of this embodiment it is made clear that the series arrangement of the flashback arrester 5 and pressure relief valve 4 is of a random nature and can be freely chosen. As compared with this, the embodiment of FIG. 2 has the advantage that the flashback arrester 5 is integrated in advantageous manner in the area of the housing main section 9 sectionwise surrounded by the thread 15, which can lead to a reduction in the overall length. Alternatively the overall length can be reduced in that the flashback arrester 5 is constructed as a sintered filter 8.

### REFERENCE NUMERALS LIST

Pressure relief device
Implement interior
Exterior
Pressure relief valve
Flashback arrester
Perforated supporting disk
Filter
Sintered filter
Housing main section
Shoulder
Housing intermediate part
Housing cover section
Sealing ring
Reception ring
Rupture disk
Thread

1. Device for internal pressure relief of a pig movable through a pipeline and/or a working implement introduced in pressure-tight sealed manner into an external pressure medium and having a pressure relief valve, characterized by at least one rupture disk placed downstream of the pressure relief valve in the pressure relief direction.

2. Device according to claim 1, characterized in that compared with its inside facing the pressure relief direction, the rupture disk withstands an at least ten times higher pressure on its outside.

3. Device according to claim 1, characterized by at least one flashback arrester, which is arranged in series with the pressure relief valve and rupture disk.

4. Device according to claim 3, characterized in that the flashback arrester is positioned upstream of pressure relief valve and/or upstream of rupture disk in the pressure relief direction.

5. Device according to claim 1, characterized in that the rupture disk opens as from a pressure of approximately 20 bar acting on its inside in the pressure relief direction.

6. Device according to claim 1, characterized by at least one filter, which is arranged in series with the pressure relief valve and rupture disk.

7. Device according to claim 6, characterized in that a filter is provided as the last element of the row in the pressure relief direction.

8. Device according to claim 6, characterized in that a filter is placed between pressure relief valve and rupture disk in the pressure relief direction.

9. Device according to claim 1, characterized in that the pressure relief valve, rupture disk and optionally flashback arrester are integrated into a common housing.

10. Device according to claim 9, characterized by a sealing ring for the pressure seal of the area of the pressure relief valve adjacent to the inner wall of housing.

11. Device according to claim 9, characterized in that the housing has a main section (9), an intermediate part, a cover section and a pressure-tight connection between at least two of the individual sections, particularly between the main section and intermediate part.

12. Device according to claim 11, characterized in that the pressure-tight connection is formed by welding individual sections of housing.

13. Device according to claim 11, characterized in that the pressure relief valve and flashback arrester are integrated into the main section of housing.

14. Device according to claim 10, characterized in that at least one filter is integrated into the cover section and/or main section of housing.

15. Device according to claim 10, characterized in that the rupture disk is integrated in pressure-tight manner into the intermediate part of housing.

16. Device according to claim 9, characterized in that the housing has a thread for pressure-tight connection to the implement housing.

17. Device according to claim 16, characterized in that the thread conforms with the provisions of a pressure-resistant encapsulation according to European standard EN 60079-1.

18. Device according to claim 3, characterized in that the flashback arrester conforms with the regulations concerning a pressure-resistant encapsulation according to European standard EN 60079-1.

19. Explosion-protected housing of a pig movable through a pipeline and/or some other pressure-tight sealed working implement introduced into an external pressure medium, characterized by at least one device according to claim 1 for removing internal overpressures in the outer area of the housing.

20. Device according to claim 6, characterized in that at least one filter is integrated into the cover section and/or main section of housing.
